(19) United States
(12) Patent Application Publication
(10) Pub. No.: US 2026/0252559 A1
(43) Pub. Date: Aug. 27, 2026

(54) RETRIEVAL TOKEN GENERATION FROM QUERIES USING LANGUAGE MODEL

(71) Applicant: Google LLC, Mountain View, CA (US)

(72) Inventors: Jordan N. Gergov, San Jose, CA (US); Yen Chang, Sunnyvale, CA (US); Michael Simbirsky, Stanford, CA (US); Kumar Avinava Dubey, Palo Alto, CA (US)

(21) Appl. No.: 18/858,806

(22) PCT Filed: May 28, 2024
(86) PCT No.: PCT/US2024/031216

§ 371 Date: Oct. 22, 2024

Related U.S. Application Data
(60) Provisional application No. 63/505,615, filed on Jun. 1, 2023.

(51) Int. Cl. G06F 16/2453; G06N 3/08

(52) U.S. Cl. CPC G06F 16/24542; G06N 3/08

(57) ABSTRACT

Methods, systems, and apparatus, including computer programs encoded on a computer storage medium, for training a large language model (LLM) to predict generalizations of public queries. The generalizations are then used to generate retrieval tokens for annotating the public queries.

### BACKGROUND

This specification relates to data processing and, in particular, the use of a language model to generate retrieval tokens.

Digital components, which are discrete units of digital content or digital information, are selected for inclusion with digital content that is served to a requesting user device. To select the digital components to be served, a system needs to be able to evaluate which digital components would be best to serve for a particular serving instance. One way of selecting a digital component is by use of keywords that are associated with the digital component.

However, finding the keywords to associate with a digital component can be challenging. The keywords are typically based on digital content, such as queries that have been received by the serving system. There are often billions of queries to choose from. Moreover, some systems generalize the queries so that the queries can be searched by a provider of the digital components or by a recommendation process that can identify keywords to be associated with the digital components.

To enable efficient searching of these queries, the queries are annotated with retrieval tokens. Determining which retrieval tokens to use to annotate a particular query can be challenging. The systems that make such determinations are often relevance-and traffic-based processing systems that process many different sources of information, such as URL text, text of web resources, and the like. Moreover, updating these systems can be time consuming and difficult.

### SUMMARY

In general, one innovative aspect of the subject matter described in this specification can be embodied in methods that include the actions of obtaining a plurality of training samples, each training sample comprising one or more queries, each query of the one or more queries being a query selected from a query store; training a language model to generate a trained language model, wherein the trained language model predicts, for each training sample, one or more generalizations that describe the training sample, each generalization of the one or more generalization being an n-gram; processing, by the trained language model, the queries stored in the query store to predict, for each query, one or more generalizations for the query; for each query, determining, from the one or more generalizations predicted for the query, one or more retrieval tokens for the query; and storing, in a data store and for each query, an association of the query with the one or more retrieval tokens determined for the query. Other embodiments of this aspect include corresponding systems, apparatus, and computer programs, configured to perform the actions of the methods, encoded on computer storage devices.

These and other embodiments can each optionally include one or more of the following aspects. In an aspect, training language model to generate the trained language model includes, for each training sample, training the model to predict a seed keyword that is a generalization of the training sample.

In an aspect, obtaining a plurality of training samples includes, for each training sample: providing, as input to a retrieval process, a seed keyword, accessing a data store that that stores, for each query of a plurality of queries an association of the query with the one or more retrieval tokens, and selecting, based on the one or more retrieval tokens and the seed keyword, one or more queries as a training sample.

In an aspect, training the language model to generate the trained language model includes, for each training sample, training the model to predict the seed keyword that was provided as input to the retrieval process to obtain the one or more queries as the training sample.

In an aspect, each query selected from the query store is a query that has been received as an input query to a search process and generated by a user of the search process.

In an aspect, determining, from the one or more generalizations predicted for the query, one or more retrieval tokens for the query includes determining that each of the one or more generalizations is a retrieval token.

In an aspect, determining, from the one or more generalizations predicted for the query, one or more retrieval tokens for the query includes determining, from the one or more generalizations, one or more retrieval tokens, wherein the one or more retrieval tokens define a set of terms that are different from a set of terms defined by the one or more generalizations.

In an aspect, for each query, determining, from the one or more generalizations predicted for the query, one or more retrieval tokens for the query includes, for each query: selecting one or more context queries for the query, providing the query and the one or more context queries as an input to the language model, and receiving, from the language model, one or more generalizations predicted for the query based on the query and the one or more context queries.

In an aspect, the language model is one of a multitask unified model, zero-shot model, domain specific model, or a language representation model.

Particular embodiments of the subject matter described in this specification can be implemented so as to realize one or more of the following advantages. The techniques discussed in this specification obviate the need to periodically re-tune and adjust relevance-based generalization processes, as the language model learns emergent semantics from a corpus of queries. Additionally, by training on actual queries that have been received, and generating retrieval tokens for these queries, the likelihood of hallucination is reduced or even eliminated. Moreover, once the model is trained, the model is used to process a corpus of queries to generate retrieval tokens for each query. The queries are then associated with their respective retrieval tokens and persisted to a data storage system for parallel processing and retrieval. Thus, there is no need to execute the language model at run time, which conserves processing resources.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a process of generating retrieval tokens can be performed.

FIG. 2A is an illustration of a user interface for a keyword selection process.

FIG. 2B is a system flow diagram of the keyword selection process.

FIG. 3 is a system flow diagram of a process for training a language model to predict generalizations of queries.

FIG. 4 is a flow diagram of a process for generating retrieval tokens using a language model.

FIG. 5 a block diagram of an example computer.

Like reference numbers and designations in the various drawings indicate like elements.

### DETAILED DESCRIPTION

The technology described in this written description relates to a large language model (LLM) that is trained to predict generalizations of public queries. The generalizations are then used to generate retrieval tokens for annotating the public queries. By training on public queries to generate the retrieval tokens, the likelihood of LLM hallucination of a factually invalid query is eliminated or greatly reduced. This is because the retrieval tokens generated or derived from the LLM output are used to return public queries at run time, instead of the LLM itself returning a predicted query as output.

The LLM, once trained, is used to generate generalizations for each query in a set of queries that are to be annotated. Once retrieval tokens are generated from the generalizations, the retrieval tokens are used to annotate the queries. The annotated queries are then persisted in a data storage system in a search system. At run time, when a system is required to generate keywords to be used based on a seed input, the LLM need not be used to generate the keywords, as the annotations and queries are accessed through the data store.

In an implementation, the LLM is trained on an existing corpus of public queries and associated retrieval tokens. Seed keywords are used to retrieve subsets of the public queries. In particular, the training samples that are used to train the LLM are generated by providing, to an existing retrieval process, seed keywords. For each seed keyword, the retrieval process selects, based on the one or more retrieval tokens and the seed keyword, one or more queries as a training sample. The LLM is then trained to predict the seed keywords based on the training samples.

These features and additional features are described in more detail below.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

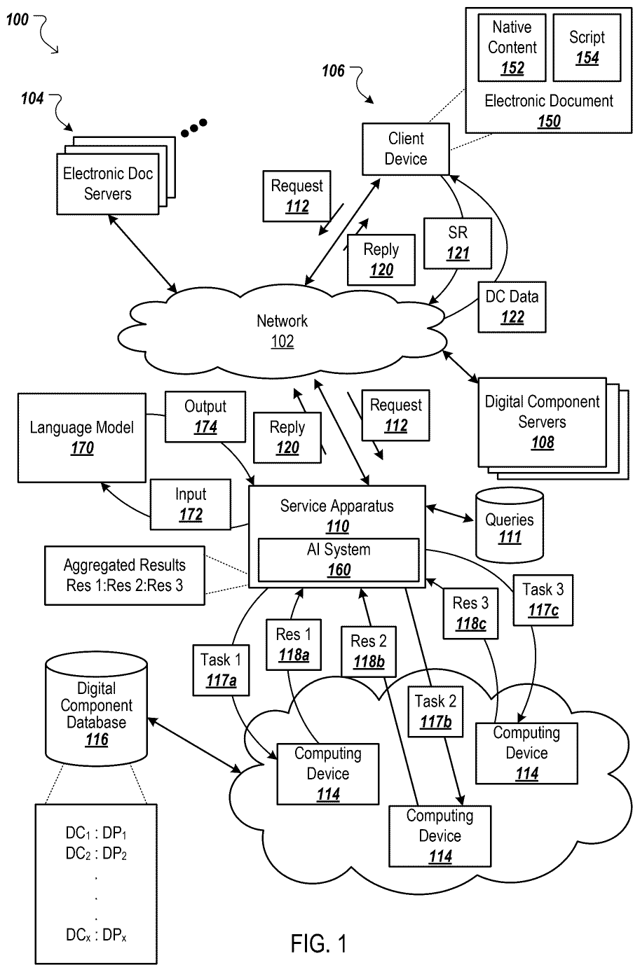

FIG. 1 is a block diagram of an example environment 100 in which a process of generating retrieval tokens can be performed. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page. Queries received by users of, for example, a search system, may be stored in a query storage 111.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence system 160 configured to generate data for the identification of digital components. As described in more detail throughout this specification, the artificial intelligence (“AI”) system 160 can generate retrieval tokens for queries and annotate the queries. These annotations are then used by providers of digital components to identify keywords that are used to identify the particular digital components. A keyword may be a single word or term or may be a combination of terms and numbers.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code. An LLM can also be trained for a particular task. In the implementations described in this document, the LLM is trained to predict generalization of an input text. For example, for an input 172 of one or more queries, the LLM may generate, as output 174, generalizations of the input 172.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CORR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020. Such example models include multitask unified model, a zero-shot model, a domain specific model, or a language representation model.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

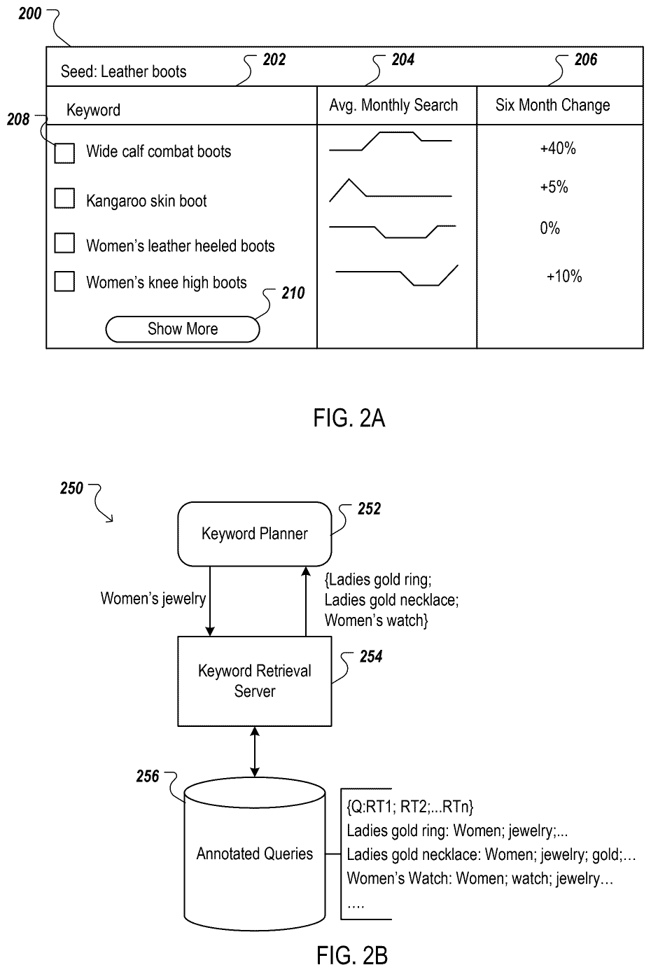

As described above, the language model 170 can generate retrieval tokens for queries and annotate the queries. These annotations are then used by providers of digital components to identify keywords that are used to identify the particular digital components. One way that providers identify keywords is by use of a keyword selection process. An example keyword selection process is described with reference to FIGS. 2A and 2B. In particular, FIG. 2A is an illustration of a user interface 200 for a keyword selection process, and FIG. 2B is a system flow diagram 250 of the keyword selection process.

In FIG. 2A, a user has input a seed “leather boots” into a keyword selection process user interface 200. The user interface 200 includes three columns-a keyword column 202, an average month search column 204, and a six month change column 206. The keyword column 202 lists keywords that are returned in response to the seed “leather boots.” The keywords, in some implementations, are public queries that have been received from users. The average month search column 204 and the six month change column 206 show statistics related to a particular keyword. The user may evaluate the statistics and the keyword and determine whether to select the keyword for inclusion into criteria for selecting a digital component. For example, if the digital components are advertisements, the keywords that are selected could be associated with an advertising campaign that includes the advertisements.

A keyword may be selected by checking a corresponding selection box 208. Additional keywords can be displayed by selecting a “show more” button 210.

In the system flow diagram of FIG. 2B, the keyword planner process 252 submits a seed to a keyword retrieval server 254. Here, the seed is “women's jewelry.” The keyword retrieval server 254 accesses a data storage 256 that stores annotated queries. The queries are annotated in the form of {Q: RT1, RT2 . . . RTn}, where RT is a retrieval token. As used herein, a retrieval token is a token, such as a single word, a combination of words and terms, or even a short phrase, that is used to annotate a query. The retrieval tokens for a particular query can be interpreted as semantic generalizations of the query. A particular retrieval token may correspond to a particular word in a multi-word query or may correspond to two or more words in a multi-word query.

The keyword retrieval server 254 may use one or more evaluation processes to select keywords based on a seed. These evaluation processes may include a relevance evaluation process, word matching processes, a query quality evaluation process, and other evaluation processes that can be used to evaluate response to a seed. As shown in FIG. 2B, the seed “women's jewelry” has returned the keywords “ladies gold ring,” “ladies gold necklace,” and “women's watch.” While only three keywords are shown, in practice, dozens, hundreds or even thousands of keywords may be returned in response to a seed.

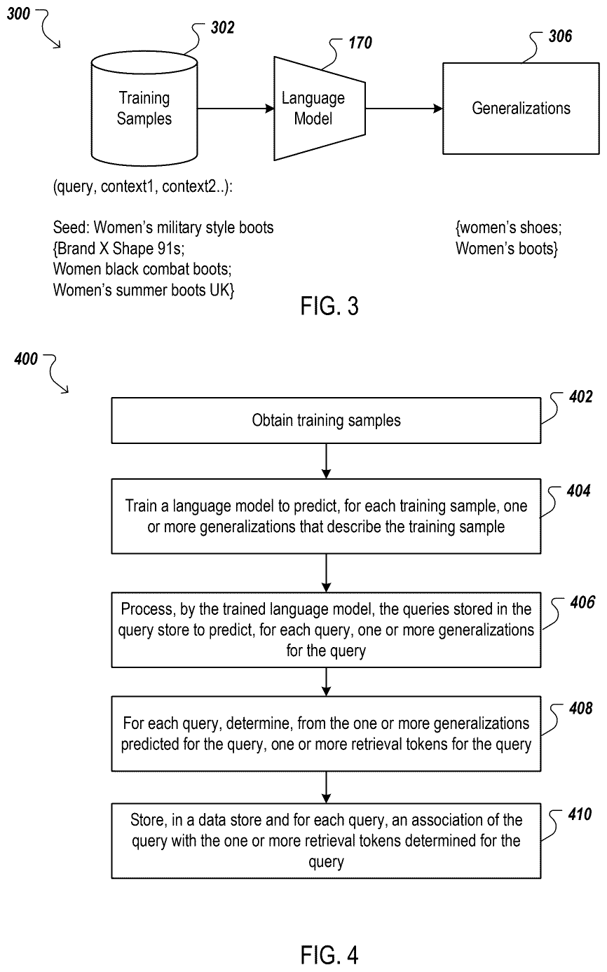

FIG. 3 is a system flow diagram of a process 300 for training a language model to predict generalizations of queries. The process 300 is described with reference to FIG. 4, which is a flow diagram of a process 400 for generating retrieval tokens using a language model. The process 400 is implemented in a computer system that typically includes multiple processors.

In operation, the process 400 obtains training samples (402). Each training sample includes one or more queries, and each query of the queries is a query selected from a query store, such as the query storage 111 of FIG. 1. Each query is a query that has been received as an input query to a search process and generated by a user of the search process.

One example way of generating a training sample is to provide a seed to a keyword planner process, such as the process 250 of FIG. 2B. For example, each training sample is generated by providing a seed keyword to the retrieval process. As shown in FIG. 3, for the seed “women's military style boots,” the training sample {Brand X Shape 91s; women's black combat boots; women's summer boots UK} is generated. The term “Brand X” is a brand name, and the term “Shape 91s” is a product name. The training sample is generated by accessing the data store 256 of queries that are each annotated with one or more retrieval tokens, and the queries are selected based on the one or more retrieval tokens and the seed keyword. The training samples 302 are generated for multiple seeds such that enough training samples are generated to train the language model 170.

The process 400 trains the language model 170 to predict, for each training sample, one or more generalizations that describe the training sample (404). Each generalization is an n-gram of one or more terms. For example, as shown in FIG. 3, for the training sample {Brand X Shape 91s; women's black combat boots; women's summer boots UK}, the generalizations 306 that are generated are {women's shoes; women's boots}. The generalizations shown in FIG. 3 are for a model 170 that is nearing completion of the training process. However, when the training process beings, the generalizations may be far less accurate.

In some implementations, the model 170 is trained so that the one or more generalizations include the seed keyword that was used to generate the training sample. For example, for the training sample {Brand X Shape 91s; women's black combat boots; women's summer boots UK} that correspond to the seed keyword “women's military style boots,” the output of the model 170 will be one or more generalizations that include the seed keyword “women's military style boots” as a generalization.

In some implementations, the language model 170 is trained to predict generalizations that are then post-processed to determine the retrieval tokens. For example, the generalizations may be processed to remove stop words, e.g., “the,” “and,” etc., and may be processed to remove words or terms that are too general, e.g., “thing,” “product,” etc.

In other implementations, the language model 170 may be trained to predict generalizations that need not be post processed to determine the retrieval tokens. Instead, the predictions are such that each of the one or more generalizations is a retrieval token.

Once the model 170 is trained, the queries stored in the query store are processed by the trained model 170 to predict, for each query, one or more generalizations for the query (408). For example, a single query may be input to the trained model 170 and the model may predict the generalizations based on the single query.

In another implementation, the query to be annotated may be included with one or more other queries selected as context queries. Then, the query and the one or more context queries are input to the language model 170, and one or more generalizations predicted for the query based on the query and the one or more context queries are received.

Then the process 400, for each query, determines from the one or more generalizations predicted for the query, one or more retrieval tokens for the query (408). As described above, the language model 170 may be trained to predict generalizations that are then post-processed to determine the retrieval tokens. For example, the generalizations may be processed to remove stop words, e.g., “the,” “and,” etc., and may be processed to remove words or terms that are too general, e.g., “thing,” “product,” etc. In other words, the one or more retrieval tokens define a set of terms that are different from a set of terms defined by the one or more generalizations.

Alternatively, the language model 170 may be trained to predict generalizations that need not be post processed to determine the retrieval tokens, and instead the predictions are such that each of the one or more generalizations is a retrieval token. In other words, wherein the one or more retrieval tokens define a set of terms that are the same as the set of terms defined by the one or more generalizations.

The process 400 then stores, in a data store and for each query, an association of the query with the one or more retrieval tokens determined for the query (410). For example, the process 400 may store the annotated queries in the data store 256 of FIG. 2B. Once stored, the annotated queries may be used for keyword selection, such as described with reference to FIGS. 2A and 2B.

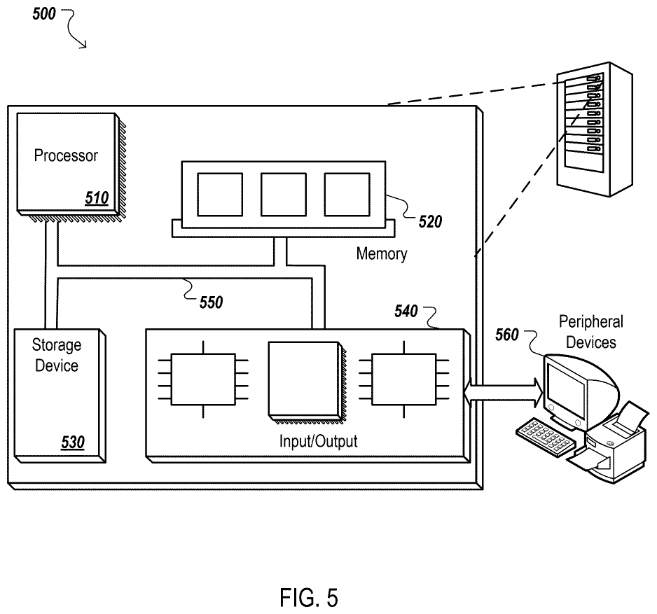

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method, comprising:
obtaining a plurality of training samples, each training sample comprising one or more queries, each query of the one or more queries being a query selected from a query store;
training a language model to generate a trained language model, wherein the trained language model predicts, for each training sample, one or more generalizations that describe the training sample, each generalization of the one or more generalization being an n-gram;
processing, by the trained language model, the queries stored in the query store to predict, for each query, one or more generalizations for the query;
for each query, determining, from the one or more generalizations predicted for the query, one or more retrieval tokens for the query; and
storing, in a data store and for each query, an association of the query with the one or more retrieval tokens determined for the query.

2. The computer-implemented method of claim 1, wherein training the language model to generate the trained language model comprises, for each training sample, training the model to predict a seed keyword that is a generalization of the training sample.

3. The computer-implemented method of claim 1, wherein obtaining a plurality of training samples comprises, for each training sample:
providing, as input to a retrieval process, a seed keyword;
accessing a data store that stores, for each query of a plurality of queries an association of the query with the one or more retrieval tokens; and
selecting, based on the one or more retrieval tokens and the seed keyword, one or more queries as a training sample.

4. The computer-implemented method of claim 3, wherein training the language model to generate the trained language model comprises, for each training sample:
training the model to predict the seed keyword that was provided as input to the retrieval process to obtain the one or more queries as the training sample.

5. The computer-implemented method of claim 1, wherein each query selected from the query store is a query that has been received as an input query to a search process and generated by a user of the search process.

6. The computer-implemented method of claim 1, wherein determining, from the one or more generalizations predicted for the query, one or more retrieval tokens for the query comprises determining that each of the one or more generalizations is a retrieval token.

7. The computer-implemented method of claim 1, wherein determining, from the one or more generalizations predicted for the query, one or more retrieval tokens for the query comprises determining, from the one or more generalizations, one or more retrieval tokens, wherein the one or more retrieval tokens define a set of terms that are different from a set of terms defined by the one or more generalizations.

8. The computer-implemented method of claim 1, wherein for each query, determining, from the one or more generalizations predicted for the query, one or more retrieval tokens for the query comprises:
selecting one or more context queries for the query;
providing the query and the one or more context queries as an input to the language model; and
receiving, from the language model, one or more generalizations predicted for the query based on the query and the one or more context queries.

9. The computer-implemented method of claim 1, wherein the language model is one of a multitask unified model, zero-shot model, domain specific model, or a language representation model.

10. A system, comprising:
one or more computers in data communication; and
one or more non-transitory computer readable medium storing instructions executable by the one or more computers that when executed by the one or more computers cause the one or more computers to perform operations comprising:
obtaining a plurality of training samples, each training sample comprising one or more queries, each query of the one or more queries being a query selected from a query store;
training a language model to generate a trained language model, wherein the trained language model predicts, for each training sample, one or more generalizations that describe the training sample, each generalization of the one or more generalization being an n-gram;
processing, by the trained language model, the queries stored in the query store to predict, for each query, one or more generalizations for the query;
for each query, determining, from the one or more generalizations predicted for the query, one or more retrieval tokens for the query; and
storing, in a data store and for each query, an association of the query with the one or more retrieval tokens determined for the query.

11. The system of claim 10, wherein training the language model to generate the trained language model comprises, for each training sample, training the model to predict a seed keyword that is a generalization of the training sample.

12. The system of claim 10, wherein obtaining a plurality of training samples comprises, for each training sample:
providing, as input to a retrieval process, a seed keyword;
accessing a data store that that stores, for each query of a plurality of queries an association of the query with the one or more retrieval tokens; and
selecting, based on the one or more retrieval tokens and the seed keyword, one or more queries as a training sample.

13. The system of claim 12, wherein training the language model to generate the trained language model comprises, for each training sample:
training the model to predict the seed keyword that was provided as input to the retrieval process to obtain the one or more queries as the training sample.

14. The system of claim 10, wherein each query selected from the query store is a query that has been received as an input query to a search process and generated by a user of the search process.

15. The system of claim 10, wherein determining, from the one or more generalizations predicted for the query, one or more retrieval tokens for the query comprises determining that each of the one or more generalizations is a retrieval token.

16. The system of claim 10, wherein determining, from the one or more generalizations predicted for the query, one or more retrieval tokens for the query comprises determining, from the one or more generalizations, one or more retrieval tokens, wherein the one or more retrieval tokens define a set of terms that are different from a set of terms defined by the one or more generalizations.

17. The system of claim 10, wherein for each query, determining, from the one or more generalizations predicted for the query, one or more retrieval tokens for the query comprises:
selecting one or more context queries for the query;
providing the query and the one or more context queries as an input to the language model; and
receiving, from the language model, one or more generalizations predicted for the query based on the query and the one or more context queries.

18. The system of claim 10, wherein the language model is one of a multitask unified model, zero-shot model, domain specific model, or a language representation model.

19. One or more non-transitory computer readable medium storing instructions, that when executed by an artificial intelligence system, causes the artificial intelligence system to perform operations comprising:
obtaining a plurality of training samples, each training sample comprising one or more queries, each query of the one or more queries being a query selected from a query store;
training a language model to generate a trained language model, wherein the trained language model predicts, for each training sample, one or more generalizations that describe the training sample, each generalization of the one or more generalization being an n-gram;
processing, by the trained language model, the queries stored in the query store to predict, for each query, one or more generalizations for the query;
for each query, determining, from the one or more generalizations predicted for the query, one or more retrieval tokens for the query; and
storing, in a data store and for each query, an association of the query with the one or more retrieval tokens determined for the query.
